(19) United States
(12) Patent Application Publication
(10) Pub. No.: US 2009/0006018 A1
(43) Pub. Date: Jan. 1, 2009

(54) Quality management system

(75) Inventors: James A. Hutchins, Fountain Inn, SC (US); Keith C. Anderson, Chapin, SC (US)

Correspondence Address: CATERPILLAR/FINNEGAN, HENDERSON, L.L.P., 901 New York Avenue, NW, WASHINGTON, DC, 20001-4413, US

(73) Assignee: FG Wilson (Engineering) Ltd.

(21) Appl. No.: 11/819,914

(22) Filed: Jun. 29, 2007

(51) Int. Cl. G01N 37/00

(52) U.S. Cl. 702/82

(57) ABSTRACT

A quality management system is provided, having a first workstation including a first graphical user interface configured to display information regarding at least one process and a second workstation located remote from the first workstation and including a second graphical user interface configured to display information regarding the at least one process. The system may also include a computer-readable medium having stored thereon instructions for collecting and storing data from the at least one process. The computer-readable medium may also include instructions for displaying, on the first graphical user interface, information derived from the collected data in real-time with respect to the collection of the data. Further, computer-readable medium may include instructions for transferring the collected data, or the information derived from the collected data, to the second workstation and displaying, on the second graphical user interface, the information derived from the collected data.

### TECHNICAL FIELD

The present disclosure is directed to a quality management system and, more particularly, to a quality management system configured for real-time data analysis and communication.

### BACKGROUND

Historically, manufacturing companies have collected large amounts of data regarding quality and overall production performance. However, any data that is collected must be analyzed in some way to produce meaningful information. Further, such information must be considered by individuals who are responsible for effecting change. Once data is collected, the ensuing process can take days, weeks, or even months, before the data is entered, compiled and/or processed to produce useful information, forwarded to a responsible party, and acted upon by the responsible party based on the forwarded information.

Systems have been developed to facilitate and expedite quality management processes. For example, U.S. Patent Application Publication No. 2006/0020503 to Harris et al. (hereinafter “the '503 publication”) discloses systems and methods for tracking employee job performance. The system disclosed in the '503 publication may be configured to receive performance data from a craftsperson and generate a report, which may be used by, for example, a supervisor to monitor the job performance of the craftsperson in what is alleged to be “real time.”

While the system of the '503 publication may be configured to monitor a craftsperson's job performance, the system does not provide any means for communication between users of the system. In addition, the system does not facilitate on-demand transfer of data via the communication system. Further, the system does not provide any capability for customization of checklists for the manufacturing process and/or quality inspection and, therefore, also does not enable modification of such checklists based on collected data.

The present disclosure is directed toward overcoming one or more of the problems discussed above.

### SUMMARY OF THE INVENTION

In one aspect, the present disclosure is directed to a quality management system. The system may include a first workstation including a first graphical user interface configured to display information regarding at least one process and a second workstation located remote from the first workstation and including a second graphical user interface configured to display information regarding the process. The system may also include a computer-readable medium having stored thereon instructions for collecting and storing data from the process. The computer-readable medium may also include instructions for displaying, on the first graphical user interface, information derived from the collected data in real-time with respect to the collection of the data. Further, the computer-readable medium may include instructions for transferring the collected data, or the information derived from the collected data, to the second workstation and displaying, on the second graphical user interface, the information derived from the collected data.

In another aspect, the present disclosure is directed to a quality management method. The method may include collecting and storing data from at least one process and displaying, on a first graphical user interface at a first workstation, information derived from the collected data in real-time with respect to the collection of the data. The method may also include transferring the collected data, or the information derived from the collected data, to a second workstation located remote from the first workstation and including a second graphical user interface configured to display information regarding the process. The method may further include displaying, on the second graphical user interface, the information derived from the collected data.

### BRIEF DESCRIPTION OF THE DRAWINGS

FIG. 1 is a diagrammatic illustration of various components of a quality management system according to an exemplary disclosed embodiment.

FIG. 2 is a diagrammatic illustration of an assembly line implementation of a quality management system according to an exemplary disclosed embodiment.

FIG. 3 is a diagrammatic illustration of a graphical user interface (GUI) illustrating an exemplary display of a manufacturing checklist according to an exemplary disclosed embodiment.

FIG. 4 is a diagrammatic illustration of a graphical user interface (GUI) illustrating an exemplary display of an inspection checklist according to an exemplary disclosed embodiment.

FIG. 5 is a diagrammatic illustration of a graphical user interface (GUI) illustrating an exemplary display of an inspector workstation according to an exemplary disclosed embodiment.

FIG. 6 is a diagrammatic illustration of a graphical user interface (GUI) illustrating an exemplary display of a technician workstation according to an exemplary disclosed embodiment.

FIG. 7 is a diagrammatic illustration of a graphical user interface (GUI) illustrating an exemplary display of an observational workstation according to an exemplary disclosed embodiment.

FIG. 8 is a diagrammatic illustration of a graphical user interface (GUI) illustrating an exemplary display of a mobile repair unit according to an exemplary disclosed embodiment.

FIG. 9 is a flowchart illustrating an exemplary quality management process.

### DETAILED DESCRIPTION

Reference will now be made in detail to the drawings. Wherever possible, the same reference numbers will be used throughout the drawings to refer to the same or like parts.

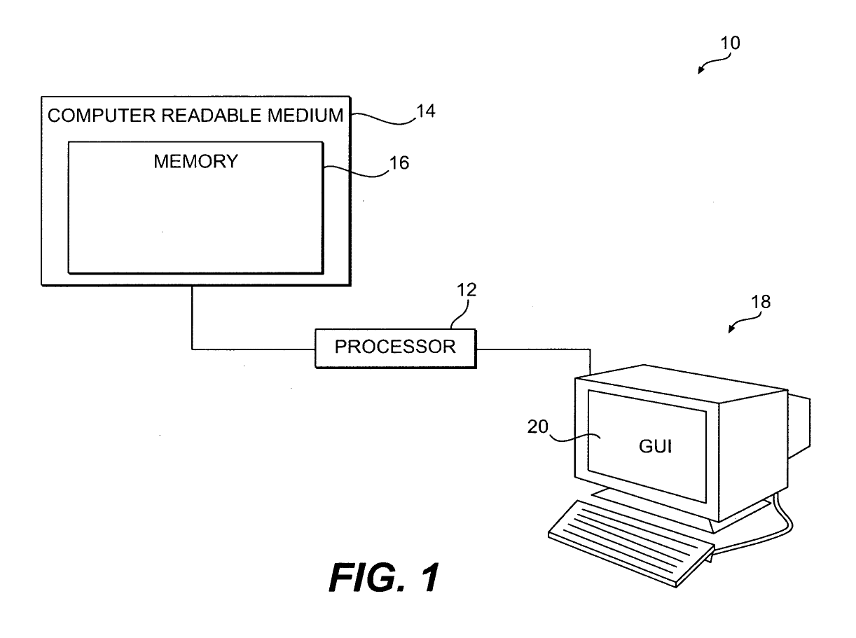

FIG. 1 illustrates a quality management system 10. System 10 may be configured to orchestrate various processes of an industry, such as the manufacturing industry. Exemplary manufacturing processes may include, but are not limited to, production, quality inspections, and rectification (e.g., repairs) of problems discovered by such inspections, as well as shipping, etc. The disclosed concept is discussed herein with respect to a manufacturing process and an associated facility. However, the applicability of the disclosed system is far more widespread, as discussed in greater detail below.

System 10 may include a processor 12 and a computer-readable medium 14 operatively coupled to processor 12. Computer-readable medium 14 may include any type of computer-readable medium including, for example computer chips and secondary storage devices, including hard disks, floppy disks, optical media, CD-ROM, or other forms of RAM or ROM. Computer-readable medium 14 may include a memory 16 having stored thereon data, information, and instructions for performing certain functions. System 10 may also include at least one graphical user interface (GUI) 18 configured to display information regarding the manufacturing process.

GUI 18 may include any type of display device or equipment. For example, GUI 18 may include a display 20, which may be configured to provide visual feedback regarding system 10 and its components and functions. Display 20 may be any kind of display, including, for instance, a screen display, as shown in FIG. 1. For example, display 20 may include a cathode ray tube (CRT), liquid crystal display (LCD), plasma screen, or the like. In addition to providing visual feedback regarding functions of system 10, display 20 may also be configured to accept input. In such an embodiment, display 20 may include, for example, a touch screen. Display 20 may also provide other information regarding any other device and/or system associated with system 10.

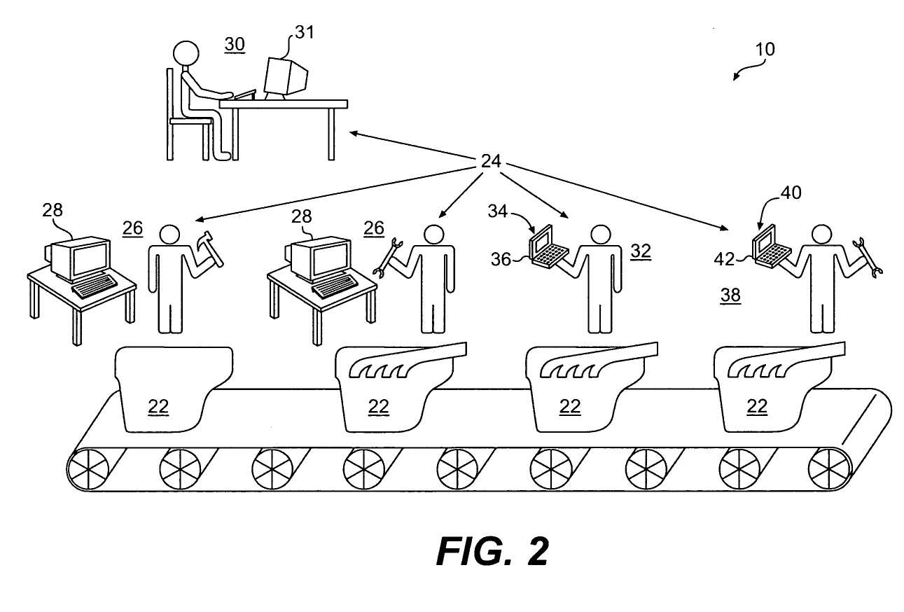

As shown in FIG. 2, system 10 may be implemented on an assembly line for assembling any type of equipment or machine. Such equipment may include engines 22, as shown in FIG. 2, automobiles, or any other types of machines or devices.

As shown in FIG. 2, system 10 may include a number of workstations 24, each of which may include a GUI. Workstations 24 may be networked, and thus, may be configured to communicate with each other. In such embodiments, computer-readable medium 14 may include multiple components, which may be located at multiple locations (e.g., at different workstations of the network). For example, each workstation may include a memory and/or other forms of computer-readable media.

As shown in FIG. 2, system 10 may include one or more technician workstations 26. Technician workstations 26 may include technician graphical user interfaces 28, which may be configured to display information regarding the at least one manufacturing process. Technicians may interact with technician graphical user interfaces 28 to receive and/or retrieve information regarding the tasks they are employed to perform as part of the manufacturing process. For example, technicians may view checklists and/or instructions for performing their respective tasks, view productivity and quality data regarding their own work and/or the work of others, and communicate with other users of system 10 via technician graphical user interfaces 28.

System 10 may also include at least one observational workstation 30, which may include an observational graphical user interface 31. Observational workstation 30 may be utilized by a supervisor, group manager, facility manager, or any other individual having an interest in overseeing the productivity and quality of the manufacturing process. In some embodiments, system 10 may include more than one observational workstation 30. Also, in some embodiments, a system administrator may access system 10 from an observational workstation 30. In addition, observational workstations 30 may be located off-site for use by outside users (e.g., vendors, suppliers, customers, etc.). Outside users are discussed in greater detail below.

In addition, system 10 may include at least one inspection workstation 32. While inspection workstation 32 may have one or more predetermined locations, inspection workstation 32 may include a mobile inspection unit 34 configured to be used for inspection of one or more aspects of the manufacturing process at a location other than inspection workstation 32. This may allow for routine or occasional inspections at various locations within the manufacturing facility. Mobile inspection unit 34 may include an inspection unit graphical user interface 36, which may be configured to display information regarding the at least one manufacturing process. Mobile inspection unit 34 may include any type of portable electronic device, such as a laptop or tablet computer (as shown in FIG. 2), a personal data assistant (PDA), or any other handheld or otherwise portable equipment.

In some embodiments, system 10 may include at least one repair workstation 38. Repair workstation 38 may include a mobile repair unit 40 configured to be used by a user of system 10 to repair one or more pieces of equipment related to the manufacturing process at varying locations within the manufacturing facility. Mobile repair unit 40 may include a repair unit graphical user interface 42, which may be configured to display information regarding the at least one manufacturing process. Similar to mobile inspection unit 34, mobile repair unit 40 may include any type of portable electronic device, such as a laptop computer (as shown in FIG. 2), a personal data assistant (PDA), or any other handheld or otherwise portable equipment.

System 10 may be implemented on a local network, e.g., within a manufacturing facility or within a manufacturing company. In some embodiments, the network of system 10 may be accessible to certain users external to the facility. For example, system 10 may be Internet-based and, as such, may be displayed by display 20 as one or more web pages available on a local or global network.

User access to system 10 and/or various aspects thereof may be regulated based on a plurality of security access categories. For example, various categories and/or levels of security access may be granted to users based on a number of factors. Users may be given limited or restricted access to only certain aspects of system 10, based on their association with the company employing system 10 to manage the manufacturing process. For example, different levels of security access may be granted to users based on whether or not a user is an in-house user of the company hosting the system (e.g., an employee of the host company) or an outside user (e.g., contract employee, vendor, etc.); the type of work a user does; the geographic region in which the user works; the business/manufacturing facility at which the user works; etc.

In-house users may include those who access system 10 from within a host company of system 10. A host company may include any company that operates system 10 for use by its employees, its members, or other outside users; maintains/supports system 10 for the benefit of another company; and/or serves as administrator/manager of system 10. An outside user may be one who accesses system 10 from outside the host company (i.e., not in-house). For example, an outside user may include an outside vendor (e.g., an entity that may supply the host company with parts and/or tools for the assembly process managed by system 10). In some embodiments, outside users may access system 10 any number of ways, such as via the Internet or via any other kind of communications data link or portal.

Different levels of security access may grant users access to differing aspects of system 10, such as tools and/or information. For example, the outside user company may or may not be granted access rights to information that is stored in system 10 that is proprietary or otherwise maintained confidential by the host company. Additionally or alternatively, the outside user may, based on their security access level, have access to different features and/or levels of performance of system 10. For example, depending on the access level, certain aspects of system 10 that the outside user company has access to may be more powerful or less powerful, such as with regard to the level of detail/information displayed by GUI 18, and/or detail and function of navigation tools for retrieving/viewing information, e.g., reports, productivity data, quality inspection data, etc. Similar varying levels of access may be granted to different in-house users. For example, an assembly line technician may have access to view performance data regarding only his own workstation, whereas a team leader, supervisor, or other member of mid/upper level management may have access to view data from multiple workstations, groups of workstations, or the entire manufacturing facility.

The disclosed system may be configured to collect data regarding any process for which production parameters, such as productivity and/or quality, may be monitored and managed. This data collection may be performed in any suitable way. The manufacturing process may be broken down into units that will be referred to herein as “work orders.” A work order may include, e.g., an order for the overall assembly of a product or an order for the completion of one or more tasks performed as part of the manufacturing process of a product. For each work order, a technician may be called upon to perform a task which includes a number of subtasks, each of which may be listed on a checklist for the technician to complete. The checklist may be electronic and displayed by any GUI 18 of system 10.

One basic form of data collection may be implemented in the following manner. Upon completing a work order, the technician who performed the task or subtask involved may be required to indicate that the work order has been completed by some form of data entry. For example, as the technician completes the work order and the subtasks thereof, he may record the completion of the tasks and/or subtasks electronically in system 10 via GUI 18 at one of technician workstations 26 (e.g., by checking a box on an electronic checklist).

System 10 may be configured to compile data collected in the aforementioned manner and/or in other ways. System 10 may be further configured to display, based on the compiled data, information about the productivity of the technician, the workstation where he works, the team of technicians with whom he works, the entire facility, etc. and/or the quality of the work performed thereby. This information may be provided to one or more parties. For example, the information may be displayed at the technician's workstation, and/or made available to a supervisory authority, a management/ownership entity, a supplier, a customer, and/or any other interested party. The information may be sent in an alert message to certain parties and/or may be made accessible to certain parties upon request (e.g., by querying system 10).

Computer-readable medium may include instructions for creating and maintaining electronic checklists that are related to the manufacturing process and which are customizable by a user of system 10. System 10 may enable users to create their own checklists, for example, by choosing from a stored list of tasks/subtasks. New tasks/subtasks may also be added to (and/or removed from) system 10 by users having an appropriate level of security access to system 10. Accordingly, instructions for manufacturing, inspection, and/or repair processes may be easily created, modified, and/or updated in a short amount of time. For example, checklists for a variety of processes may be updated as quickly as an authorized user enters a change in system 10. The following example illustrates the virtual immediacy with which such updates may be effective. In one conceivable scenario, a customer may call a contact at a manufacturer with a complaint about a product defect. Before the phone conversation is over, the contact at the manufacturer may access any and all information in system 10 relating to the defect reported by the customer, including the frequency with which the defect occurs. In addition, the contact may add or modify a task or comment on an inspection checklist associated production of the product in question and convey to the customer that the customer's complaint has been addressed.

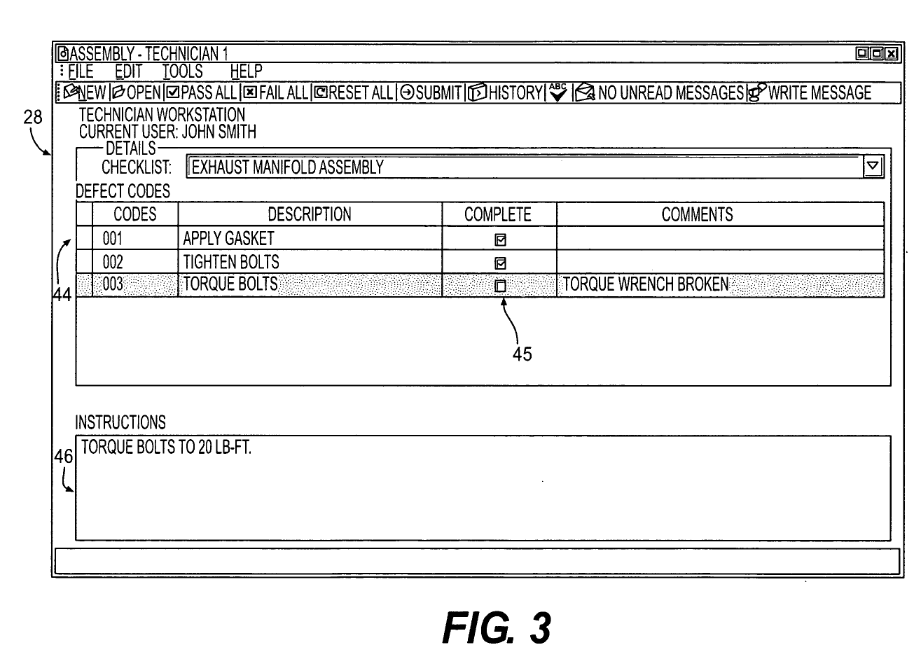

FIG. 3 shows an exemplary manufacturing checklist 44, including check boxes 45. As shown in FIG. 3, the various items on a checklist may be selected and, upon selection, further information about the selected item may be displayed. For example, an instructions section 46 may include detailed instructions regarding a selected assembly task. In the example illustrated in FIG. 3, task code number 003, which is entitled “Torque Bolts,” is selected. When the “Torque Bolts” task is selected, details such as the torque spec to which the bolts should be tightened may appear in instructions section 46. These instructions may be customized for each task and may be modifiable by users of system 10 having an appropriate level of security access.

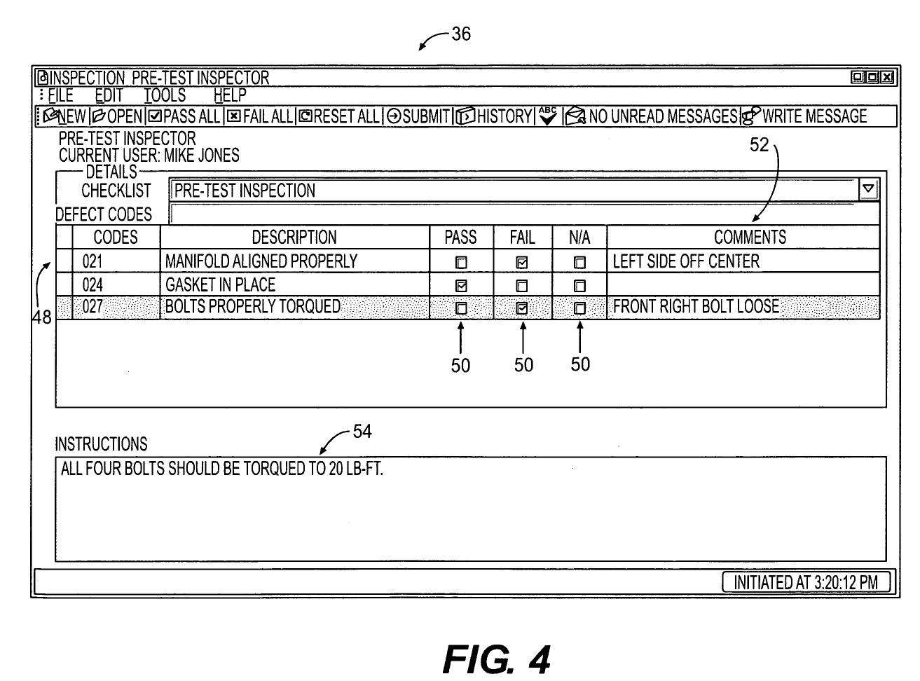

At one or more stages during and/or after production, the product being assembled may undergo an inspection. For example, in an engine manufacturing facility, a final inspection may be conducted prior to testing the operation of the completed engine (i.e., “pre-test inspection”). Such inspections may also be performed according to one or more checklists. FIG. 4 illustrates an exemplary inspection checklist 48. For example, items on checklist 48 may be checked off, in a series of check boxes 50, as “pass,” “fail,” or “N/A.” Comments may also be added in a comments section 52, for example, to describe failed items.

In many situations, an inspection checklist may include many items corresponding to items in the manufacturing checklist by which the work order was completed. For example, for manufacturing checklist 44 (see FIG. 3), which includes task code number 003 instructing a technician to torque bolts to a particular torque specification, the corresponding inspection checklist 48 may include an item instructing the inspector to ensure that the bolts are properly torqued. For such an inspection item, an instructions section 54 may include the proper torque spec, as in manufacturing checklist 44. In some embodiments, for a particular measured specification, such as a torque value to which a bolt should be tightened, the tolerance or margin of acceptable error may be hidden from an inspector, but accessible by others with a higher or different level of security clearance. This ensures an objective evaluation of the measured specification, preventing an inspector from, for example, passing an inspected measured specification because the measurement fell only slightly outside the acceptable tolerance. The inspector could be required to simply enter a torque measurement and system 10 could evaluate whether the measured torque falls within the margins of acceptable error. In some embodiments, the tool with which a measurement may be taken may be configured to directly transfer measurement data to system 10, thus bypassing any proactive entry on the part of the inspector.

Each of the various aspects of the manufacturing process may have at least one defect code associated therewith, which may be selected if the one or more aspects fail inspection. Information derived from the collected data may be generated for review and/or analysis. Information derived from the collected data may include, for example, a list of defect codes associated with one or more work orders, work stations, technicians, departments, etc. Computer-readable medium 14 may include instructions for generating a list of all the work orders for which a particular defect code has been selected during an inspection.

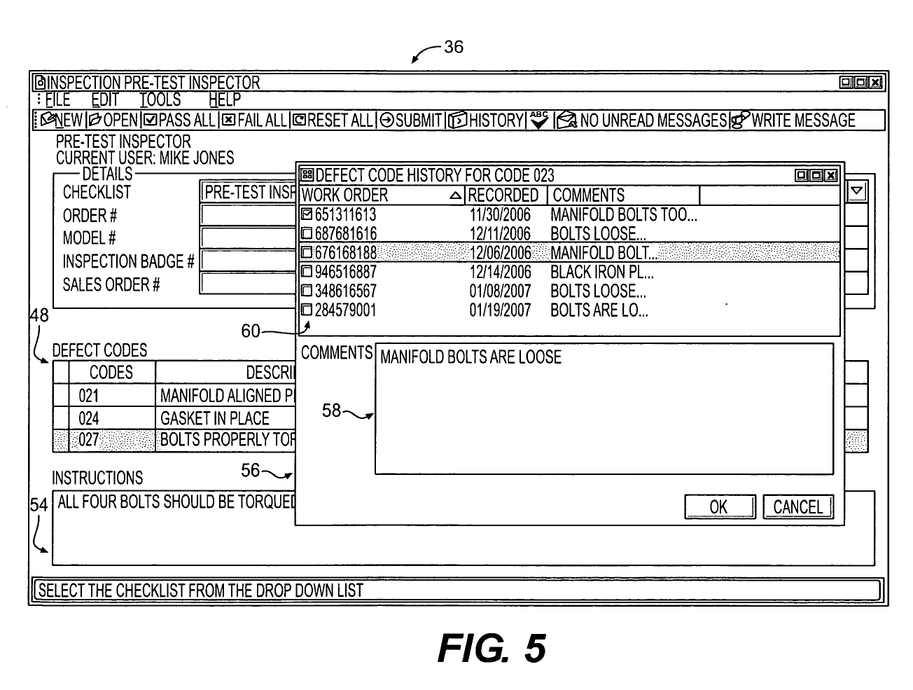

Additional data may be retrieved for each defect code. For example, as shown in FIG. 5, by selecting a particular defect code, all the work orders in which the selected failure occurred may be displayed in a new defects window 56, or in a designated section of display 20. Comments for each instance of failure, from the inspector who performed the inspection, may be displayed in a comments section 58. Defects window 56 may also include check boxes 60 enabling the user to select one or more work orders. A list of the selected work orders may be forwarded via system 10 to another user for consideration.

In some embodiments, system 10 may include a messaging system configured to transfer messages between users of workstations 24. The messages may include the collected data and/or the information derived from the collected data. For example, the selected list of work orders discussed in the previous paragraph may be attached and/or incorporated into a message that may be sent by the user to one or more other users of system 10. If a particular failure seems to be happening frequently, an inspector may retrieve a list, such as shown in FIG. 5, of all the incidents where that failure occurred, and select exemplary instances of the failure. System 10 may be configured to attach a list of the selected instances of failure to a message, which may be sent to an interested party, such as other inspectors, technicians, management, or other persons who may play a role in reducing the frequency with which the failure occurs. The message may include additional comments added by the sender, such as advice on how to avoid the failure, or simply a reminder to double check for a particular issue at the time of production and/or inspection. This messaging system may function much like an email system, and thus, messages may also be sent that include only the sender's comments and do not include any attached data. This feature of system 10 may enable technicians and other users to respond quickly and easily to inquiries about performance and/or quality.

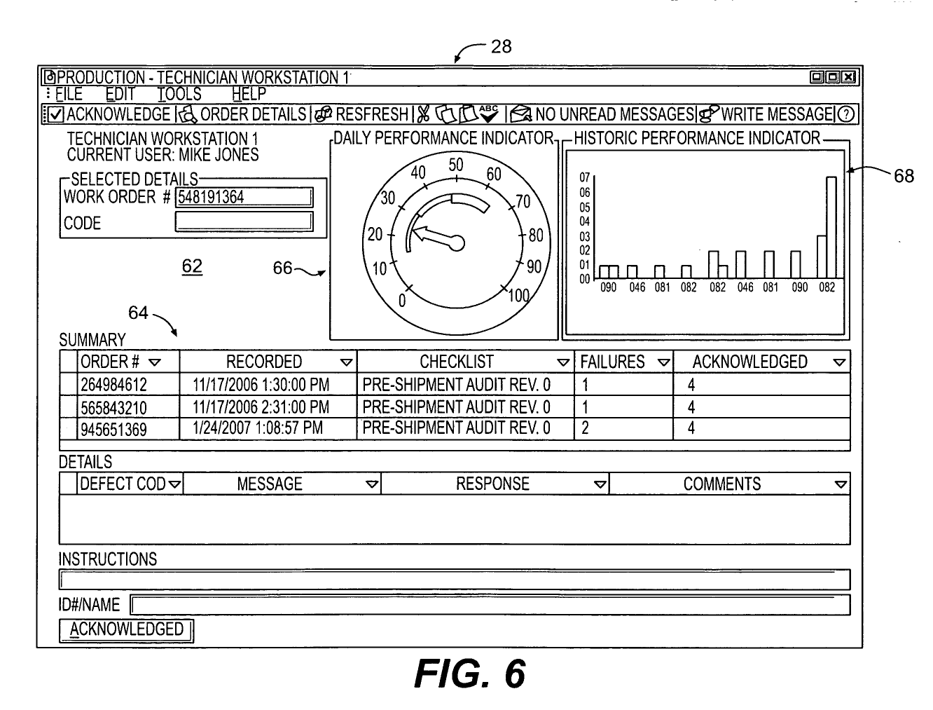

Using the messaging system, the results of the inspections, including the inspectors' comments may be stored, and routed immediately to one or more destinations, such as, for example, back to the technician's workstation, to a supervisor, etc. The results may be displayed, or rendered available for viewing, in real time, such that a technician, his supervisor, and/or any other interested party may have the data displayed in front of him, for example in a dashboard/instrument panel type display (e.g., see FIG. 6). Alternatively or additionally, the data may be routed by system 10, via the messaging system or some other module of system 10, to a central server where the data may be available for viewing by parties granted access to appropriate aspects of the system and/or displayed at a different workstation 24.

Repair checklists may also be generated by users of system 10. System 10 may be configured to facilitate creation of repair checklists in much the same way that manufacturing checklists and/or inspection checklists are created. It may be appropriate to have separate manufacturing checklists and repair checklists because the procedure for repairing a defect or manufacturing flaw may be different than the procedure for initially assembling the product.

Computer-readable medium 14 may have stored thereon instructions for collecting and storing data from the manufacturing process. Computer-readable medium 14 may also include instructions for displaying, on a GUI at a workstation, the collected data or information derived from the collected data in real-time with respect to the collection of the data. For purposes of this disclosure, the term “real-time” shall refer to the immediate or substantially immediate availability of data as a transaction or event occurs from which data is collected. That is, data may be retrieved and available for analysis as quickly as it can be entered, acquired, or otherwise recorded in system 10. Such retrieval and availability may be virtually instantaneous or may take a few seconds or minutes to complete. For example, data may be available and, in some cases, displayed immediately or substantially immediately after a technician completes a work order and checks the last of checkboxes 45 on manufacturing checklist 44.

As shown in FIG. 6, production parameters, such as total work orders completed and/or detected defects, may be displayed in a real-time, virtual instrument panel 62 on GUI 18. A display such as shown in FIG. 6 may be automatically displayed at any number of locations (e.g., on technician graphical user interfaces 28 at technician work stations 26, observational workstation 30, etc.) and/or may be called up upon request, for example, by a member of upper management, who may have access to drill down through various levels of the performance data. Accordingly, computer-readable medium 14 may include instructions for transferring the collected data, or information derived from the collected data, to any of workstations 24 remotely located with respect to the workstation where the data was initially collected and/or displayed. Computer-readable medium 14 may further include instructions for displaying, on the GUI of the remotely located workstation 24, the collected data and/or information derived from the collected data.

For purposes of this disclosure, a workstation that is “remotedly located” or “located remote from” another workstation may be separated from the other workstation by any distance. For example, “remote” may refer to workstations located in separate facilities. Alternatively, “remote” may refer to different physical locations within a facility. The distance between workstations may be small, and thus, “remote” may indicate not only distance separating workstations, but also simply that the workstations are separate and distinct from one another. For example, two technician workstations 26 may be located next to one another and still be remote from one another.

In some embodiments, the transfer of collected data, or the information derived from the collected data, may be performed automatically. For example, the information may be processed and automatically transferred from a technician's workstation to the workstation of the technician's supervisor. This transfer of information may be made in real-time or in incremental batch transfers. In some embodiments, the information may be sent to the supervisor and displayed in a real-time virtual instrument panel on the GUI at the supervisor's workstation.

In some embodiments, the transfer of collected data, or the information derived from the collected data, may be performed on demand of a user. For example, upon viewing collected data, a user may wish to make that data available to one or more other users.

As shown in FIG. 6, data for each work order may be displayed (see summary section 64). Virtual instrument panel 62 may include a daily performance gauge-type indicator (gauge 66) and an historical performance indicator (graph 68). Gauge 66 and graph 68 may serve as easily readable displays for technicians, supervisors, and other users to assess current performance in real time. Virtual instruments, like gauge 66 and graph 68 or other types of data displays, may indicate any type of collected data. For example, gauge 66 and/or graph 68 may indicate data such as total work orders completed, average time taken to complete each work order, or total defects detected over a predetermined time frame (e.g., daily, weekly, etc.).

In some embodiments, gauge 66 and/or graph 68 may indicate defects per unit of production (e.g., defects per million work orders or “DPM”). In addition, the virtual instruments may represent data for any division and/or subdivision of a manufacturer. For example, while gauge 66 and graph 68 may display defects in work orders completed by a particular technician or at a specific workstation, virtual instrument panel 62 may also be configured to display information about the productivity and/or defects for a group or subgroup of individuals or workstations within the manufacturer or facility.

In some embodiments, performance may be categorized in different levels based on the number of defects per million work orders. For example, there may be several tiers of performance to evaluate an individual and/or group of individuals. Each tier of performance may be associated with a different color. For example, operating at a DPM below a first predetermined DPM may be considered a “bronze” performance level, below a second, lower predetermined DPM may be considered a “silver” performance level, and a DPM below a third, even lower predetermined DPM may be considered a “gold” performance level. In some embodiments, the backgrounds of gauge 66 and/or graph 68 may change color, e.g., to gold, silver, bronze, or other colors, to indicate the current (or past) level of performance of the technician, workstation, or groups of workstations. This feature may provide a technician (or other user) with information about the individual's performance (e.g., with red and green portions of the scale on gauge 66, or respective colors of bars in graph 68), and also with information about how his team of technicians is performing (e.g., with the color-coded background of gauge 66 and/or graph 68).

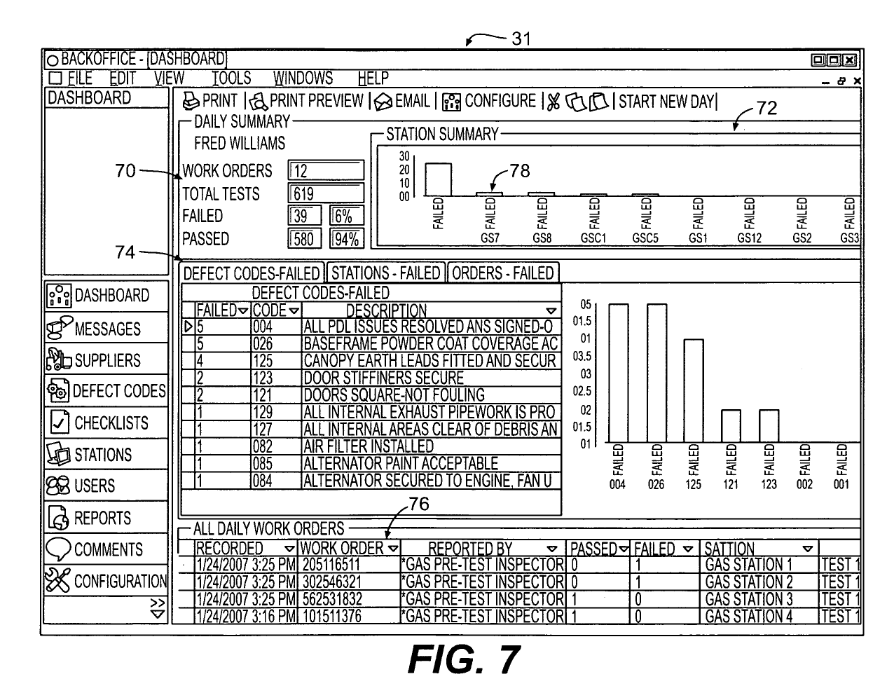

FIG. 7 illustrates an exemplary display, which system 10 may be configured to display on, for example, observational graphical user interface 31 at observational workstations 30. Such data may be displayed in real-time and may include, for example, the number of work orders performed, number of failures/defects, etc., which may be listed in a daily summary section 70. Some of the displayed data may be shown in graphical form (e.g., as shown in a station summary section 72). In addition, each failed test may have its own code. When the inspector determines that a failure has occurred, the inspector may log the failure code in system 10 for that work order. As shown in FIG. 7, the display may show, in a defect codes failed tab 74, all the different failure codes that have been detected (e.g., for a manufacturer, facility, workstation, employee, etc.) along with the number of times the failure associated with that code has been detected, as well as the description of the failure or the test which has been failed. In addition, data for each completed work order may be displayed in an all daily work orders section 76.

Drilling down and/or focusing of metrics analysis may be accomplished via a number of interface short cuts (as well as with more sophisticated search queries). For example, clicking on, or positioning a mouse cursor over, a particular graph, chart, or other item in the display may trigger display of more information about that item. For example, clicking on the GS7 failed bar graph 78 may retrieve and display (e.g., by opening a new window), information regarding the failures recorded at Gas Station 7.

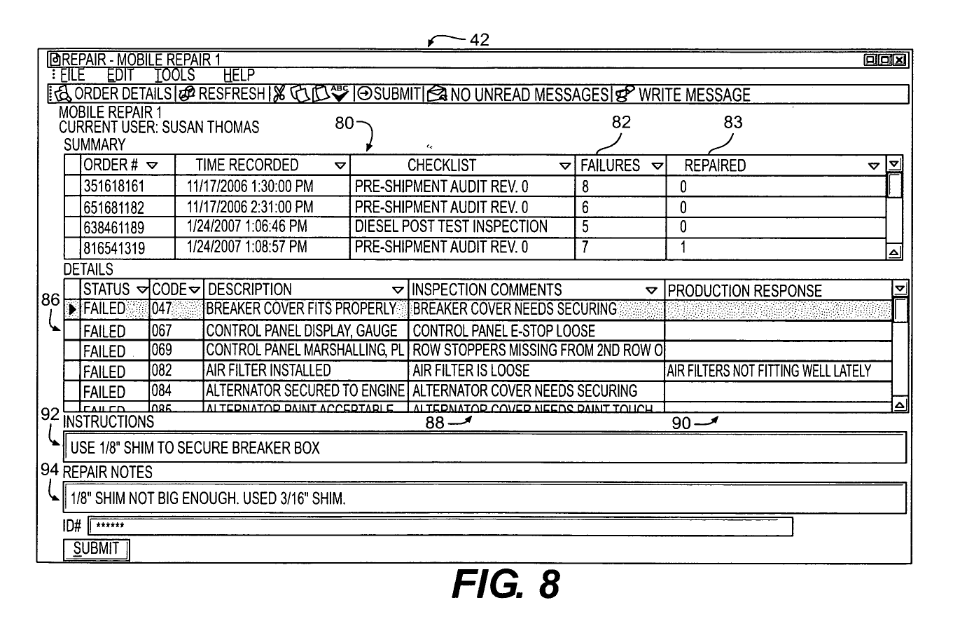

An exemplary display for mobile repair unit 40 is shown in FIG. 8. Particularly in manufacturing facilities that produce large machines (e.g., vehicles), it may be more practical for a repair technician to bring mobile repair unit 40 to the spot on the assembly line where a problem was detected (e.g., the inspection station) or to the spot on the assembly line where the machine resides shortly after the problem is detected, rather than pull the machine off the assembly line and transport it to a separate location. The repair technician may have mobile repair unit 40 at his disposal to access system 10. Mobile repair unit 40, like mobile inspection unit 34, may include a portable unit (e.g., a laptop or other handheld electronic data organizer). The repair technician may have access to any and/or all of the data discussed above.

Of particular interest to the repair technician, may be the list of failures for the given work order (i.e., the results of the inspection checklist) and/or specialized repair instructions, which may be provided formally in a repair checklist. For example, a summary section 80 may include a list of work orders that have failed inspection. As illustrated in FIG. 8, a failures column 82 and a repaired column 83 may respectively indicate, for each work order, the number of items that failed inspection and the number of items that have been repaired. More information for each failed item may be included in a details section 86.

Details section 86 may include, for example, comments from the inspector in an inspection comments section 88 for each failed item. Responsive comments from, for example, the technician who completed the work order may be included in a production response section 90.

In addition, repair instructions may be provided (e.g., in an instructions section 92) for each defect code. Comments for each repair may also be provided by the repairman in a repair notes section 94.

In some embodiments, computer-readable medium may include instructions for conditioning one or more aspects of a manufacturing, inspection, testing, and/or shipping process on successful completion of one or more predetermined items in a manufacturing, inspection, repair, or testing checklist. For example, in one embodiment, certain items on the inspection checklist may be identified as critical, whereby test equipment (e.g., equipment for bench testing an assembled engine prior to shipment to a customer) may be restricted from proceeding with the test if any critical item has failed inspection and has not yet undergone a repair procedure.

Similarly, system 10 may be configured to prevent printing of a bill of lading for shipment until certain predetermined items have passed inspection. This may be useful in situations where a particular defect occurs on a regular basis and the manufacturer's previous attempts to reduce the amount of products delivered to consumers with that particular defect have not been as effective as desired. By having a final check before shipment that the product has passed inspection for the particular defect, the manufacturer may have a very high level of confidence that the particular defect will not be found in products delivered to customers.

### INDUSTRIAL APPLICABILITY

The disclosed system may be applicable to any repetitive process for which data (e.g., information about productivity and/or mistakes) may be collected. For example, the disclosed embodiments may find applicability in any type of industry, such as, for example, manufacturing. In addition, the disclosed system may also be applicable to repair and/or overhaul procedures for products that have already been in service in the marketplace, or any other process for which data may be collected.

One benefit of the disclosed system is that it may be configured to, in real-time, process, compile, and display collected data in a meaningful way and facilitate communication between interested parties to promote fast and efficient resolution of problems and the continuation and enhancement of effective practices.

The display of real-time performance data to both technicians and management, coupled with the messaging system, enables problems to be addressed almost at the outset, rather than months later when the data would be finally analyzed in traditional quality management systems/business models. In addition, the repair of identified problems may be facilitated by the mobile repair units and the ease and speed with which the mobile repair units may be provided with information regarding the problems and instructions for fixing the problems.

Another benefit of the disclosed system is that it may promote accountability of employees for performing in their respective roles in the manufacturing, inspection, repair, and/or testing processes. In addition, the real-time collection and analysis of performance and quality data may be utilized for a number of different purposes. For example, in addition to holding employees accountable for their own performance, such data may also be used for business purposes, such as marketing to potential customers, as well as for research and development purposes. The uses of real-time performance and quality data are numerous and the examples discussed herein are intended to be exemplary only.

While the disclosed system may promote accountability of employees, such as technicians, the system also empowers such employees to effectuate change for the betterment of the manufacturer overall. The system empowers employees, such as technicians, by enabling receipt of, and prompt action in response to, comments, feedback, and other input by the technicians. Also, whereas traditional business models embody a triangle, with upper management at the top, passing information and instructions to a large number of people at the bottom, the disclosed system promotes an inverted triangle, wherein a single technician can receive information from a large number of sources, including, management, inspectors, repairmen, etc. to help him do his job better. Therefore, technician users of the disclosed system, are not only well informed about the production and quality processes and acquired data, but are also empowered to effect positive change. Because technicians often have the most intimate knowledge of the products and the assembly process, providing them with a voice that may be recognized and acted on promptly can be among the most effective ways to rectify problems, and/or improve efficiency of a process.

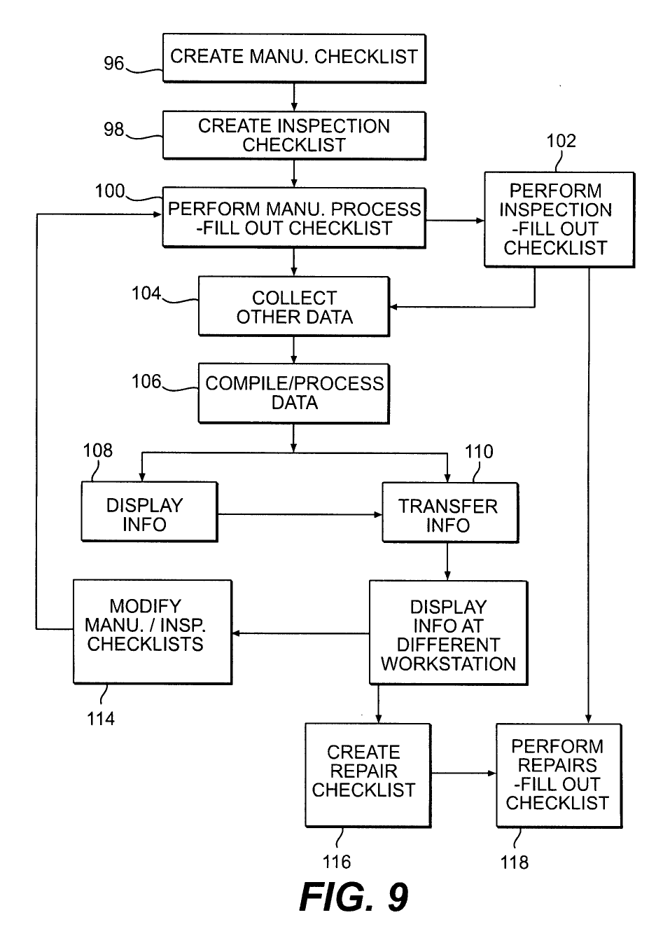

FIG. 9 is a high level flowchart illustrating, in an exemplary fashion, different aspects of the manufacturing, inspection, and repair processes discussed above. Beginning with step 96, users may utilize system 10 to create an electronic manufacturing checklist. At step 98, users may create an inspection checklist corresponding to the manufacturing checklist created in step 96. Step 96 and step 98 may be performed in any order, and may be performed by different users and/or at different workstations. Once a manufacturing checklist is available, the manufacturing process may be performed (step 100), for example, by technicians on an assembly line. As part of performing the manufacturing process at step 10, the technicians may fill out the manufacturing checklist, thus entering data into system 10.

During and/or after the manufacturing process carried out at step 100, an inspection may be performed (step 102). As part of the inspection in step 102, an inspector may fill out the inspection checklist, thus entering data into system 10. The inspection at step 102 may be carried out using a mobile inspection unit. The inspection at step 102 may include selecting at least one defect code associated with the one or more aspects of the manufacturing process if the one or more aspects fail inspection.

Other data may be collected during the course of the manufacturing process at step 104, some of which may be automatically collected from manufacturing equipment including data collection capabilities. Such equipment may be integrated with system 10.

At step 106, the data entered by the technicians at step 100, by the inspector at step 102, and by other data collection at step 104 may be compiled and/or processed, thus generating information derived from the collected data, which may include, for example, a list of defect codes associated with one or more work orders, work stations, technicians, or departments.

The compiled/processed data, and/or information derived therefrom, may be displayed (step 108) on a GUI of system 10 (e.g., the technician's workstation) and/or transferred, in step 110, to a different workstation (e.g., a supervisor's workstation). Any transferred data may be displayed at the workstation to which it has been transferred (step 112). Transfer of the collected data, or the information derived from the collected data, may be performed automatically and/or on demand of a user.

Once the data has been collected, compiled, processed, and analyzed, a number of different actions may be taken based on the resulting analysis. For example, the manufacturing and/or inspection checklists may be modified (step 114) and used to conduct the manufacturing and inspection processes going forward. Alternatively or additionally, a repair checklist may be created (step 116) to rectify one or more particular issues identified in the analysis of the data. Using the repair checklist, which may be accessible via a mobile repair unit, repairs may be performed, at step 118, on one or more pieces of equipment related to the manufacturing process. As part of the repair process, the repair checklist may be filled out, thus entering data into system 10. In some embodiments, the repair process at step 118 may be initiated more directly following completion of the inspection performed at step 102. Further, the creation of the repair checklist at step 116 may occur automatically, based on the completion of the checklist during the inspection at step 102.

The messaging system discussed above may be utilized throughout this process. The method may include transferring messages related to the collected data between users of multiple workstations. The messages may include collected data and/or information derived from the collected data, such as a list, which may be generated by a user, of all the work orders for which a particular defect code has been selected during an inspection.

In addition, data review may be carried out at any point during the process by any user with appropriate security access. The process may also include conditioning one or more aspects of a manufacturing, inspection, testing, or shipping process on successful completion of one or more predetermined items in a manufacturing, inspection, repair, or testing checklist.

Although embodiments of the invention have been described, it will be apparent to those skilled in the art that various modifications and variations can be made in the disclosed quality management system without departing from the scope of the disclosure. In addition, other embodiments of the disclosed apparatus and method will be apparent to those skilled in the art from consideration of the specification. It is intended that the specification and examples be considered as exemplary only, with a true scope of the disclosure being indicated by the following claims and their equivalents.

What is claimed is:

1. A quality management system, comprising:
a first workstation including a first graphical user interface configured to display information regarding at least one process;
a second workstation located remote from the first workstation and including a second graphical user interface configured to display information regarding the at least one process; and
a computer-readable medium having stored thereon instructions for:
collecting and storing data from the at least one process;
displaying, on the first graphical user interface, information derived from the collected data in real-time with respect to the collection of the data;
transferring the collected data, or the information derived from the collected data, to the second workstation; and
displaying, on the second graphical user interface, the information derived from the collected data.

2. The system of claim 1, wherein transferring the collected data, or the information derived from the collected data, is performed on demand of a user.

3. The system of claim 1, wherein transferring the collected data, or the information derived from the collected data, is performed automatically.

4. The system of claim 1, further including a messaging system configured to transfer messages between users of the first workstation and the second workstation;
wherein the messages include the information derived from the collected data.

5. The system of claim 1, further including instructions stored on the computer-readable medium for creating and maintaining electronic checklists that are related to the at least one process and customizable by a user of the system.

6. The system of claim 1, further including a mobile inspection unit configured to be used for inspection of one or more aspects of the at least one process and including a third graphical user interface configured to display information regarding the at least one process.

7. The system of claim 6, wherein the one or more aspects of the at least one process each have at least one defect code associated therewith, which may be selected if the one or more aspects fail inspection.

8. The system of claim 7, wherein the information derived from the collected data includes a list of defect codes associated with one or more work orders, work stations, technicians, or departments; and
further including instructions for generating a list of all the work orders for which a particular defect code has been selected during an inspection.

9. The system of claim 1, further including a mobile repair unit configured to be used by a user of the system to repair one or more pieces of equipment related to the at least one process and including a third graphical user interface configured to display information regarding the at least one process.

10. The system of claim 1, further including instructions for conditioning one or more aspects of a manufacturing, inspection, testing, or shipping process on successful completion of one or more predetermined items in a manufacturing, inspection, repair, or testing checklist.

11. A quality management method, comprising:
collecting and storing data from at least one process;
displaying, on a first graphical user interface at a first workstation, information derived from the collected data in real-time with respect to the collection of the data;
transferring the collected data, or the information derived from the collected data, to a second workstation located remote from the first workstation and including a second graphical user interface configured to display information regarding the at least one process; and
displaying, on the second graphical user interface, the information derived from the collected data.

12. The method of claim 11, wherein transferring the collected data, or the information derived from the collected data, is performed on demand of a user.

13. The method of claim 11, wherein transferring the collected data, or the information derived from the collected data, is performed automatically.

14. The method of claim 11, further including transferring messages related to the collected data between users of the first workstation and the second workstation;
wherein the messages include the information derived from the collected data.

15. The method of claim 11, further including creating and maintaining electronic checklists that are related to the at least one process and customizable by a user of the system.

16. The method of claim 11, further including performing an inspection of one or more aspects of the at least one process using a mobile inspection unit including a third graphical user interface configured to display information regarding the at least one process.

17. The method of claim 16, further including selecting at least one defect code associated with the one or more aspects of the at least one process if the one or more aspects fail inspection.

18. The method of claim 17, wherein the information derived from the collected data includes a list of defect codes associated with one or more work orders, work stations, technicians, or departments; and
further including generating a list of all the work orders for which a particular defect code has been selected during an inspection.

19. The method of claim 18, further including performing repairs on one or more pieces of equipment related to the at least one process using a mobile repair unit including a third graphical user interface configured to display information regarding the at least one process.

20. The method of claim 19, further including conditioning one or more aspects of a manufacturing, inspection, testing, or shipping process on successful completion of one or more predetermined items in a manufacturing, inspection, repair, or testing checklist.
